(19) United States
(12) Patent Application Publication
(10) Pub. No.: US 2009/0147767 A1
(43) Pub. Date: Jun. 11, 2009

(54) System and method for locating a mobile node in a network

(76) Inventor: Jin-Shyan Lee, Kaohsiung (TW)

Correspondence Address: LIN & ASSOCIATES INTELLECTUAL PROPERTY, INC., P.O. BOX 2339, SARATOGA, CA, 95070-0339, US

(21) Appl. No.: 12/053,538

(22) Filed: Mar. 21, 2008

(30) Foreign Application Priority Data
Dec. 6, 2007 (TW) 096146612

(51) Int. Cl. H04J 3/24

(52) U.S. Cl. 370/349

(57) ABSTRACT

Disclosed is a system and method for locating a mobile node in a network. The system comprises a plurality of beacon nodes, at least a router, a location host, and at least a mobile node. Each beacon node broadcasts at least a beacon signal at a first channel. A mobile node receives a plurality of beacon signals, and sends a corresponding packet's information to the location host at a second channel through a router. According to the packet's information, the location host may compute the location for the mobile node. This system distributes the communication loading to different groups and channels, which may estimate the locations for lots of mobile nodes at the same time, and gives a high communication quality and a good location estimation result.

### FIELD OF THE INVENTION

The present invention generally relates to a system and method for location estimation of a mobile node in a network.

### BACKGROUND OF THE INVENTION

The Receive Signal Strength Indication (RSSI) is to determine the distance between the transmitting end and the receiving end of a radio signal according to the radio signal strength measured by the detection circuit at the receiving end. When a mobile node receives at least three signal strength information, the signal strength information is sent to a positioning host. Based on the positioning database on the positioning host, such as a database constructed according to the experience or signal decay model, the positioning may compute to obtain the location estimation. Because RSSI is easily affected by the shadow fading in the environment, such as caused by the building absorption and reflection, or multi-path, several enhancement approaches are developed for RSSI.

For example, by using chaos processing method to generate more RSSI data from the received RSSI samples, more possible locations can be obtained, and one optimal location can be selected. Another example is to compare the RSSI in the mobile device communication and the database to obtain a positioning system suitable for outdoors and indoors. Other examples are to use probabilistic RSSI model to construct the database, to combine the RSSI and time difference of arrival (TDOA) to estimate location, or to combine RSSI and time of flight (TOF) for positioning.

The data transmission architecture of the RSSI-based positioning system may be divided into two types, as shown in the exemplary diagrams of FIG. 1 and FIG. 2, respectively.

Referring to FIG. 1, in this data transmission architecture, mobile node 101 uses active scan to request beacon from routers 103, or uses passive scan to receive beacon periodically broadcast by routers 103, to obtain at least three RSSI, marked as 11 0. Through the routers, such as routers 105A, 105B, of multi-hop mesh network 105, the packet information, such as mobile node ID, corresponding router node ID, RSSI, and so on, can be transmitted in unicast mode to location server 107 to estimate the location of mobile node 101. Location server 107 may transmit the location information of mobile node 101 to mobile node 101. In this architecture, mobile node 101 and all the routers work and transmit packets on the same channel. If NM is the number of mobile nodes, NR is the number of routers, the communication load of packet transmission is O(N_{R}*N_{M}). If the mobile nodes uses active scan to request beacon from routers 103, the load may increase to O(N_{R}*N_{M}²).

Referring to FIG. 2, in this data transmission architecture, mobile node 201 periodically broadcasts packets. Router 203 that receives the broadcast packet will obtain RSSI, marked as 215. Through the routers, such as routers 205A, 205B, of multi-hop mesh network 205, the packet information, such as mobile node ID, corresponding router node ID, RSSI, and so on, can be transmitted in unicast mode to positioning server 207. For a single mobile node, positioning server 207 must receive at least three RSSI in order to compute the location of mobile node 201, marked as 210. Similar to the architecture of FIG. 1, mobile node 201 and all the routers of FIG. 2 also work and transmit packets on the same channel, and the communication load of packet transmission is O(N_{R}*N_{M}).

In the aforementioned technologies, it is the same node to transmit beaconing signals and to transfer packets, which may easily lead to delay in positioning for multi-node positioning. Also, when beaconing signal transmission and packet transferring are both on the same channel, it is easy to cause packet collision or packet loss in multi-node positioning, and also increase the communication load.

### SUMMARY OF THE INVENTION

The primary object of the present invention may provide a system and method for locating a mobile node in a network.

In an exemplary embodiment, the disclosed is directed to a system for locating a mobile node in a network, comprising a plurality of beacon nodes, at least a router, a location host, and at least a mobile node. Each beacon node broadcasts at least a beacon signal on a first channel. Each mobile node receives a plurality of beacon signals, and transmits the information of a corresponding packet by a second channel to the location host through the at least a router. According to the corresponding packet information, the location host computes the corresponding location information of the mobile node.

In another exemplary embodiment, the disclosed is directed to a method for locating a mobile node in a network, comprising: each beacon node of a plurality of beacons nodes broadcasting at least a beacon signal on a first channel; a mobile node receiving a plurality of beacon signals on the first channel and obtaining at least three RSSIs; the mobile node transmitting the information of a corresponding packet by a second channel to a location host through at least one router; and according to the corresponding packet information, the location host computing the corresponding location information of the mobile node.

The exemplary embodiments of the present invention divide the beacon nodes transmitting location signals and the routers transferring packets into two groups. The beacon nodes transmit the beacon signals on the first channel, and the routers transfer the packets on the second channel. The location host may transmit the location information of the mobile node depending on the needs of positioning applications.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of an exemplary architecture of data transmission for an RSSI-based location system.

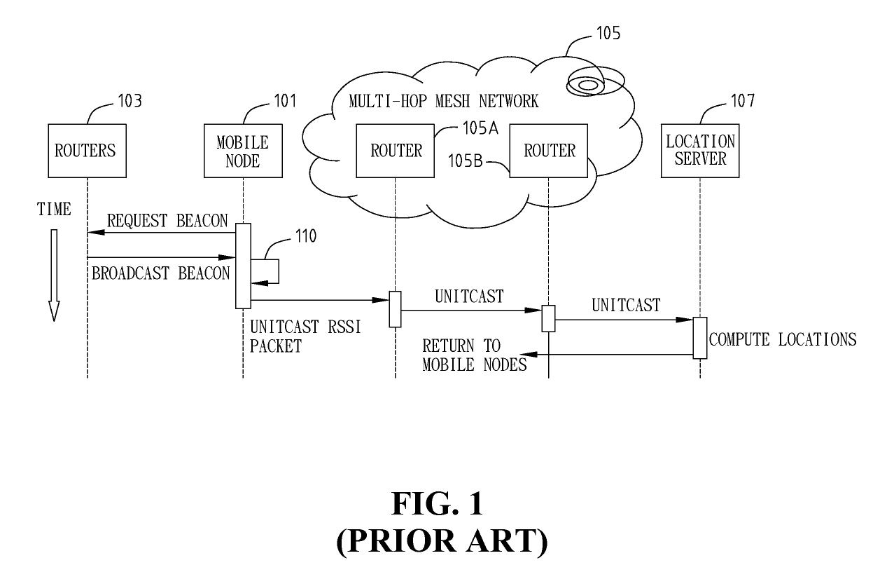

FIG. 2 shows a schematic view of another exemplary architecture of data transmission for an RSSI-based location system.

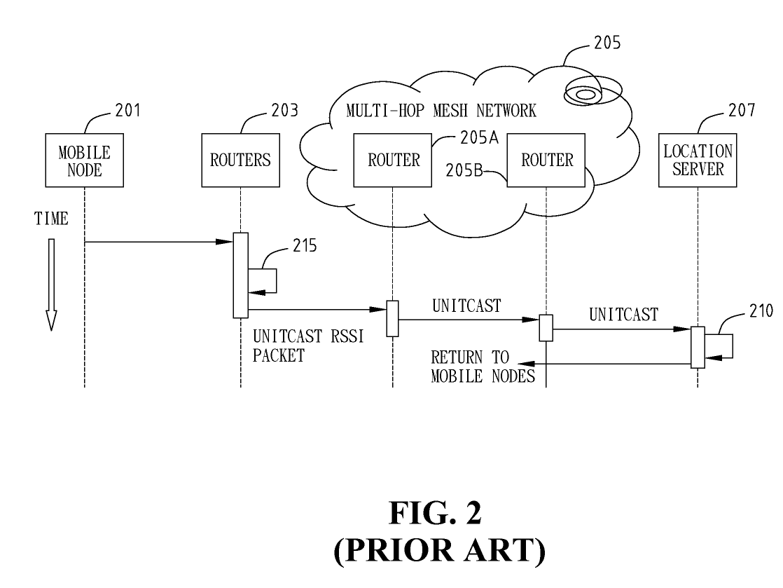

FIG. 3 shows a schematic view of an exemplary system for locating a mobile node in a network, consistent with certain disclosed embodiments.

FIG. 4 shows an exemplary flowchart illustrating the operation of a method for locating a mobile node in a network, consistent with certain disclosed embodiments.

FIG. 5 shows a schematic view of an exemplary wireless location system, consistent with certain disclosed embodiments.

### DETAILED DESCRIPTION OF THE PREFERRED EMBODIMENTS

The exemplary embodiments of the present invention use RSSI for location estimation for mobile nodes. By dividing the beacon nodes transmitting beacon signals and routers transferring packets into two groups that are working on different channels, for locating multiple mobile nodes at the same time, the communication load may be distributed to different groups and channels to reduce the packet collision delay in transmission as well as the packet loss rate.

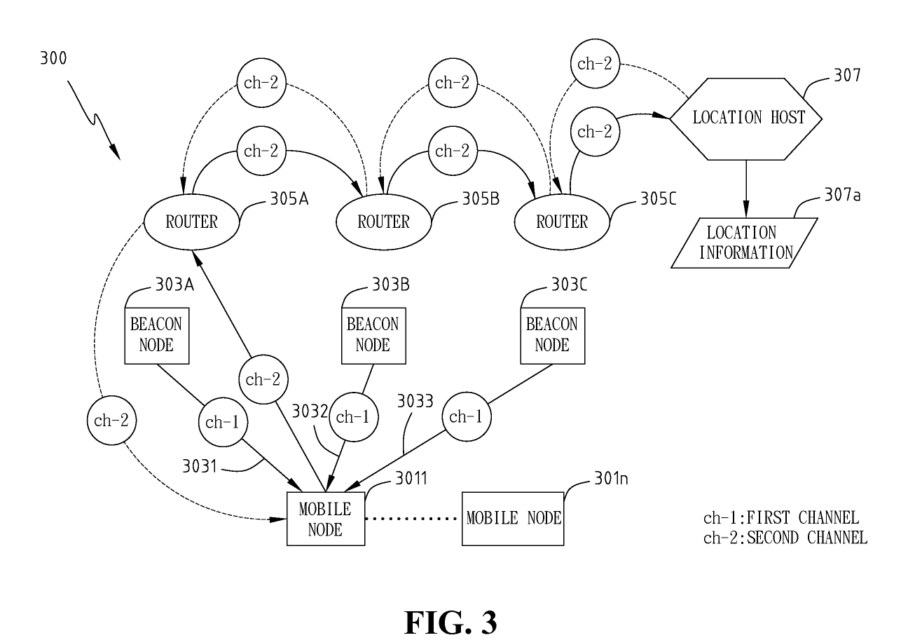

FIG. 3 shows a schematic view of an exemplary system for locating a mobile node in a network, consistent with certain disclosed embodiments. Referring to FIG. 3, location system 300 comprises a plurality of beacon nodes, at least a router, a location host, and at least a mobile node; for example, beacon nodes 303A, 303B, 303C, routers 305A, 305B, 305C, location host 307, and mobile nodes 3011-301n (n≧1). Each beacon node 303A, 303B, 303C broadcasts at least a beacon signal on a first channel. Each mobile node, e.g., mobile node 3011, receives a plurality of beacon signals, such as 3031, 3032, 3033, and through the routers, such as router 305A, to transmit the information of a corresponding packet to location host 307 through a second channel, for example, using multi-hop short distance communication to achieve long distance communication in a multi-hop mesh-type network. According to the corresponding packet information, location host 307 computes the location information 307a of a corresponding mobile node.

As shown in FIG. 3, location system 300 divides beacon nodes 303A, 303B, 303C that transmit beacon signals and routers 305A, 305B, 305C that transfer packets into two groups that work on different channels. For example, beacon nodes 303A, 303B, 303C transmit beacon signals on the first channel, and routers 305A, 305B, 305C transfer packets on the second channel.

Let N_{M} be the number of mobile nodes and N_{B} be the number of beacon nodes. In the exemplary embodiment of FIG. 3, because of the design of separate groups and channels, the communication loads on the two separate channels are O(N_{B}) and O(N_{M}), respectively. Therefore, when a large number of mobile nodes need to be estimated location at the same time, the disclosed embodiment may effectively reduce the communication load on one channel, and thus reduce the chance of communication overloading as well as packet collision delay and packet loss rate.

Each mobile node, each beacon node, each router and the location host of location system 300 all have a unique ID. The information in each packet may include its corresponding mobile ID, at least a corresponding beacon ID, and at least three RSSIs. In other words, mobile node 3011 receives at least three RSSIs on the first channel. Depending on the applications, estimated location information 307a may be transmitted to the corresponding mobile node through the second channel. For example, if the location system is for the service-based tracking application, the location host does not need to return the location information of the mobile node. On the other hand, if the positioning system is for the client-based location application, the location host needs to return the location information of the mobile node to the mobile node.

Location host 307 of location system 300 may be combined with a router or a beacon node. The location system may also be applied to a wireless platform, such as ZigBee, wireless fidelity (Wi-Fi), Bluetooth, or ultra wide band (UWB) technologies. The realization of the constituting modules of the location system may be carried in many ways, such as, a microprocessor with a built-in or external memory, short distance radio transmitter and antenna, and main power supply or battery power supply. Also, depending on the applications, a sensor may be included or excluded. Beacon nodes and routers may be either vertically or horizontally distributed and installed on the ceiling, and use the main power.

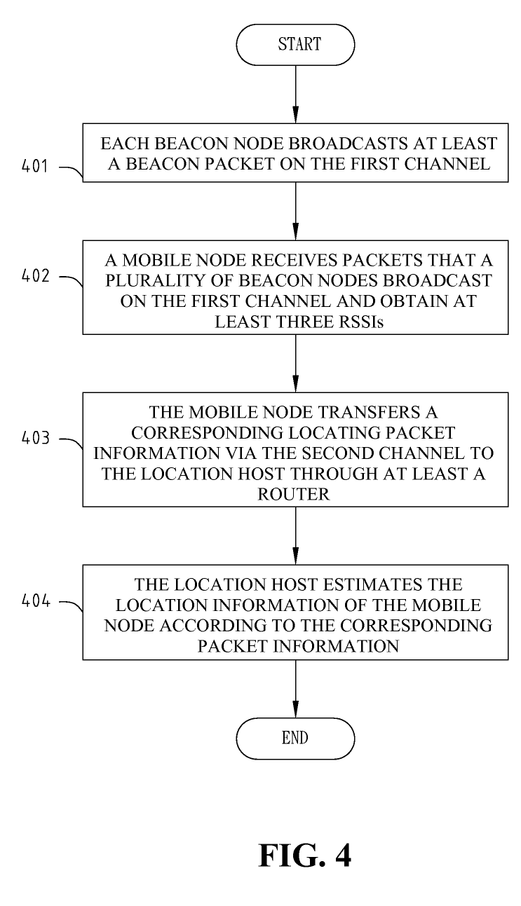

FIG. 4 shows an exemplary flowchart illustrating the operation of a method for locating a mobile node in a network, consistent with certain disclosed embodiments. Referring to FIG. 4, in step 401, each beacon node broadcasts at least a beacon packet on the first channel. For example, after each beacon node is activated, the beacon nodes may randomly broadcast beacon packets on the first channel or periodically broadcast beacon packets to reduce the packet collision. In step 402, a mobile node receives packets that a plurality of beacon nodes broadcast on the first channel and obtains at least three RSSIs. The mobile node will stay on the first channel until least three RSSIs are received.

In step 403, the mobile node transfers the information of a corresponding locating packet to the location host on the second channel through at least a router. For example, after the mobile node is activated, the mobile node joins the nearby router and views the router as a parent node to transfer the packet information on the second channel. In step 404, the location host estimates the location information of the mobile node according to the corresponding packet information. The location host receives the required location information, such as RSSIs, on the second channel from the mobile node, and may estimate the location information of the mobile node.

In this way, the beacon nodes transmitting beacon signals and the routers transferring the packets are divided into two groups and operate on different channels. In a multi-hop mesh network, in addition to the mesh connection, the packet information may also be transferred through multi-hop short distance communication to achieve long distance communication. Each communication may be limited to at most K hops, such as K=5, to increase the communication reliability. Value of K can determine the range and the number of routers deployed. The beacon nodes and the routers may be installed and deployed in a vertically or horizontally distributed manner. The mobile node may use the nearby routers to transfer the packet information on the second channel in a unicast mode.

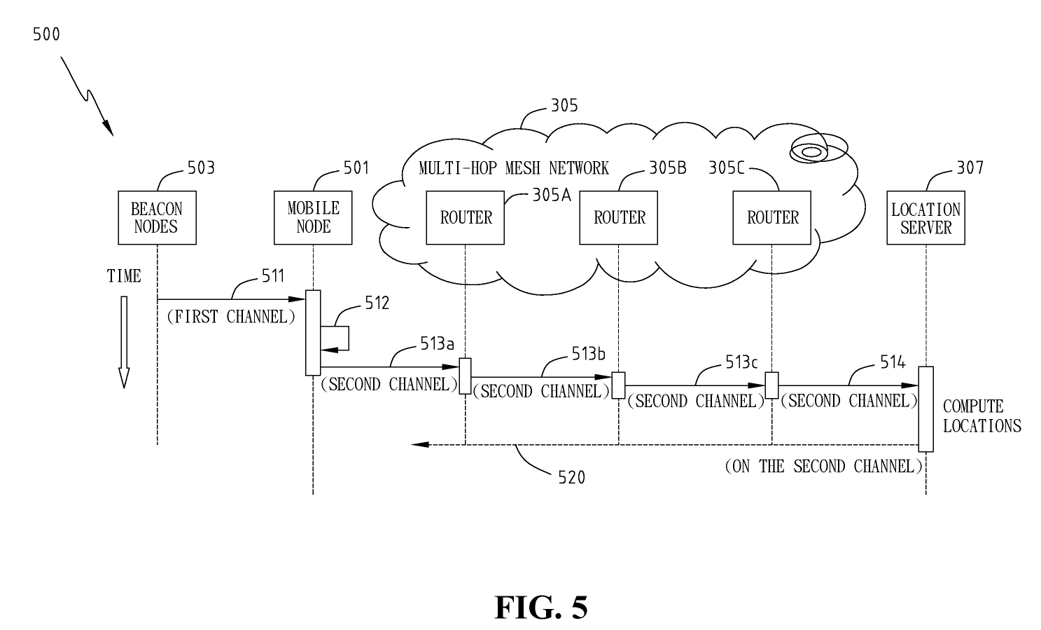

FIG. 5 shows a schematic view of an exemplary wireless location system, consistent with certain disclosed embodiments. Referring to FIG. 5, wireless location system 500 includes at least a beacon node. Each beacon node, such as beacon node 503, broadcasts a beacon packet on the first channel, marked as 511. A mobile node 501 passively receives the beacon packet, and obtains at least three RSSIs, marked as 512. Then, through a multi-hop mesh network, a locating packet is transferred on the second channel to location host 307 to estimate the location of mobile node. The locating packet information at least includes the mobile node ID, at least a corresponding beacon node ID, at least three RSSIs, and so on. The transferring of packet information is described as follows.

After receiving beacon signal, mobile node 501 transmits packet information through the second channel to the router. After the router is activated, the router processes the joining of mobile node on the second channel, and transfers the packet. The packet may be transferred in the multi-hop communication manner. For example, on the second channel, mobile node 501 transmits packet information to router 305A, marked as 513a, router 305A transmits to the next neighboring router 305B, marked as 513b, and router 305B then transmits to next router 305C, marked as 513c. Then, router 305C transmits packet information to location host 307 on the second channel, marked as 514. The maximum number K of the hops is related to the deployment range and number of the routers. In the above example, K is set as 4.

Based on the experience-based database or signal decay-based model, the location host may estimate the location of the mobile node by the RSSI. If the estimated location needs to be returned, location host 307 may send the estimated location through routers 305C, 305B, 305A back to mobile node 501 on the second channel, marked as 520. Mobile node 501 may receive on the second channel periodically.

Therefore, communication load may be distributed to different groups and channels, and thus the packet collision delay and packet loss rate during transmission can be reduced. Also, the disclosed exemplary embodiments of the present invention may improve the communication quality and locating results when simultaneously locating a large number of mobile nodes.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for locating a mobile node in a network, comprising:
a plurality of beacon nodes, each of said plurality of beacon nodes broadcasting at least a beacon signal on a first channel;
at least a router;
a location host; and
at least a mobile node for receiving said at least a beacon signal;
wherein each of said plurality of beacon nodes receives a plurality of beacon signals, and transmits a corresponding packet information on a second channel through said at least a router to said location host, and according to said packet information, said location host computes the corresponding location information of said mobile node.

2. The system as claimed in claim 1, wherein said corresponding packet information at least includes the identification of said corresponding mobile node, at least a corresponding beacon node identification, and at least three records of receive signal strength indication (RSSI) information

3. The system as claimed in claim 1, wherein each said mobile node transmits said corresponding packet information in a unicast mode on said second channel.

4. The system as claimed in claim 1, wherein said network is a multi-hop mesh network.

5. The system as claimed in claim 1, wherein said corresponding packet information is transmitted by multi-hop short distance communication to achieve long distance transmission of said corresponding packet information.

6. The system as claimed in claim 1, wherein, depending on applications, said location information of said corresponding mobile node is returned via said second channel to said corresponding mobile node.

7. The system as claimed in claim 1, wherein said system is a mobile node locating system based on RSSI.

8. The system as claimed in claim 1, wherein a router of said at least a router is the router nearby said corresponding mobile node.

9. The system as claimed in claim 1, wherein each mobile node, each beacon node, each router and said location host all have a unique ID.

10. The system as claimed in claim 1, wherein said location host is combined with a router of said at least a router.

11. The system as claimed in claim 1, wherein said location host is combined with a beacon node of said plurality of beacon nodes.

12. A method for locating a mobile node in a network, comprising:
each of a plurality of beacon nodes broadcasting at least a beacon packet on a first channel;
a mobile node on said first channel, receiving said packets broadcast by said plurality of beacon nodes, and obtaining at least three receive signal strength indication (RSSI) values from said packets;
through at least a router, transferring the information of a corresponding locating packet to a location host via a second channel; and
according to said corresponding packet information, said location host estimating location information of said mobile node.

13. The method as claimed in claim 12, wherein each of said plurality of beacon nodes broadcasts said at least a beacon packet on said first channel in a random manner or in a batch schedule manner.

14. The method as claimed in claim 12, wherein said corresponding locating packet information at least includes the identification of said mobile node, at least a corresponding beacon node identification, and at least three records of RSSI information.

15. The method as claimed in claim 12, said method uses a multi-hop short distance communication to transfer said corresponding locating packet information through said at least a router on said second channel.

16. The method as claimed in claim 12, wherein said mobile node stays on said first channel until obtaining at least three RSSI values.

17. The method as claimed in claim 12, wherein said corresponding locating packet information is transferred by a multi-hop mesh network with a plurality of routers.

18. The method as claimed in claim 12, wherein said mobile node transmits said corresponding locating packet information on said second channel in a unicast mode.

19. The method as claimed in claim 12, wherein said location host performs RSSI-based location estimation of said mobile node according to an experience-based database or a signal-decay-based model.
